(19) United States
(12) Patent Application Publication
(10) Pub. No.: US 2009/0312494 A1
(43) Pub. Date: Dec. 17, 2009

(54) Method for preparing a grafted copolymer by polyunsaturated fatty acids, copolymer grafted by polyunsaturated fatty acids obtainable by said method and uses thereof

(76) Inventors: William Bett, Paris (FR); Jean-Noël Bousseau, Paris (FR); Jean-Cristophe Castaing, Burlington, NJ (US); Franciscus Adrianus Cornelis Bergman, La Zwolle (NL); Albertus Ronald Hofkamp, Enkhuizen (NL); Gerrit Hendrik Dekker, Ijsselmuiden (NL)

Correspondence Address: NIXON & VANDERHYE, PC, 901 NORTH GLEBE ROAD, 11TH FLOOR, ARLINGTON, VA, 22203, US

(21) Appl. No.: 12/090,128

(22) PCT Filed: Oct. 13, 2006
(86) PCT No.: PCT/FR06/02309

§ 371 Date: Jul. 31, 2008

(30) Foreign Application Priority Data
Oct. 14, 2005 (FR) 0510525

(51) Int. Cl. C08L 51/00

(52) U.S. Cl. 525/78

(57) ABSTRACT

The invention concerns a method for preparing a grafted copolymer by polyunsaturated fatty acids in aqueous phase. The invention also concerns a grafted copolymer by polyunsaturated fatty acids obtainable by said method and its uses as binder in coating compositions and in particular in decorative or industrial painting compositions, in adhesive compositions or in mineral binder compositions.

The present invention relates to a process for preparing a copolymer grafted with polyunsaturated fatty acids in aqueous phase.

The invention likewise pertains to a copolymer grafted with polyunsaturated fatty acids and obtainable by this process and to its uses as a binder in coating compositions and especially in decorative or industrial paint compositions, in adhesive compositions or in mineral binder compositions.

In the field of coating compositions and in particular in industrial or decorative paint compositions it is advantageous to have storage-stable one-component binders which are able to crosslink on application.

This is because this allows good film characteristics, acquired during application, to be had, such as, for example, gloss in combination with a mechanical robustness acquired during crosslinking.

Binders for alkyd-based paints satisfy these twin demands well. These alkyd binders, however, have the disadvantage of exhibiting low chemical resistance to solvents such as methyl ethyl ketone or aromatics such as xylene and to acids, and they are sensitive to UV.

It therefore appears advantageous to enhance the durability of coating compositions by combining acrylic polymers, which are more resistant to solvents such as methyl ethyl ketone or aromatics such as xylene and to acids such as acetic acid and more stable to UV, with alkyd-type binders.

Proposals have therefore been made to produce mixtures of aqueous dispersions of acrylic (latex) (co)polymers with alkyd resins. The disadvantage of these mixtures is that the performance levels of the mixtures are not very good. This is doubtless linked to the absence of covalent bonds between the acrylic (latex) (co)polymers and the alkyd resins, and hence of crosslinking, which is therefore not favourable in particular to the solvent resistance.

Proposals have also been made to graft (co)polymers with alkyd resins.

Up until the present, in order to graft a copolymer with an alkyd resin during the synthesis of the copolymer free-radically in aqueous phase, it has been known to add acrylic monomers to the alkyd resin and to effect grafting via the available double bonds present in the alkyd resin. The polymerization is subsequently carried out by a miniemulsion technique. The available double bonds of the alkyd resin are actually present in polyunsaturated fatty acid moieties of the alkyd resin. These polyunsaturated fatty acid moieties represent only about 15% by weight of the alkyd resin, for alkyd resins whose oil length is such that they have a dust-dry time and a tack-free time which are required for decorative paint applications. The addition of the acrylic monomers therefore has the effect of diluting the fraction of polyunsaturated fatty acids, leading to lower performance levels of the resulting graft copolymer when it is used as a binder in coating compositions. In particular, when this graft copolymer is used as binder in a paint, it is sensitive to solvents, it lacks radiation resistance, and the mechanical properties are impaired.

A description has also been given, in the document WO 92/14763 of Lankwitzer Lackfabrik, of the possibility of grafting a copolymer with a methacrylate polyunsaturated fatty acid. The solubility in water of these methacrylate polyunsaturated fatty acids, however, is low.

A description was therefore given in that document of carrying out a process in a plurality of steps:
a first step in solvent phase, in which the methacrylate polyunsaturated fatty acid is copolymerized with at least one copolymerizable acid such as methacrylic acid, the purpose of this first step being to compatibilize the polymethacrylate fatty acids with water;
a second step, in which the product obtained from step 1 is placed in aqueous phase, following neutralization;
finally, the monomer mixture is polymerized in the presence of a neutralized copolymer.

In the first step of this process, however, it is necessary to form soluble alkali compounds beforehand, thereby limiting the chemical nature of the copolymer onto which the polyunsaturated fatty acid can be grafted.

Additionally this process requires the implementation of 2 steps before polymerization is commenced: one in solvent phase and then one in aqueous phase.

Owing to the step in solvent phase, residual solvent automatically remains at the end of the process, which gives rise to environmental problems.

Finally, part of the copolymer obtained by this process remains sensitive to water. This is because the fatty acid groups are in a hydrophilic environment, since they are combined with methacrylic acid. The soluble alkali compound is localized at the surface of the particles of the graft copolymer. After drying, this acid-rich interstitial zone promotes the penetration of water into the film.

The need existed to find a means of grafting a copolymer with a polyunsaturated fatty acid that does not exhibit the disadvantages described above. In other words, it should be easy to implement, in a single step rather than 2, should be able to be carried out in aqueous phase, with copolymers of a wide variety of chemical structures and identities, and should lead to good properties of this graft copolymer when it is used as a binder in coating compositions and especially in industrial or decorative paint compositions, or in adhesive compositions or mineral binder compositions such as a mortar.

One of the aims of the invention is also to prepare a graft copolymer which, when used as a binder in coating compositions, has good water resistance and solvent resistance properties, good mechanical strength of the coating, particularly with regard to radiation, and therefore, in general, a greater durability.

Another aim of the invention is also to prepare a graft copolymer which, when used as a binder in adhesive compositions or mineral binder compositions such as a mortar, has good water resistance and solvent resistance properties, good mechanical strength of the adhesive or mineral binder composition, particularly with regard to stresses, and therefore, in general, a greater durability.

These aims and others are achieved by the present invention, which first provides a process for grafting a copolymer with a polyunsaturated fatty acid, comprising the following steps:
1) a modified monomer (A) is prepared by reacting at least one glycidyl ester of acrylic acid or methacrylic acid with at least one semi-drying or drying oil fatty acid,
2) this modified monomer (A) obtained in the first step is dissolved in at least one monoethylenically unsaturated monomer (B),
3) the modified monomer (A)/monoethylenically unsaturated monomer (B) solution obtained in step 2 is then preemulsified by adding a surfactant and water with stirring, so as to give an emulsion with a water continuous phase, in other words an oil-in-water emulsion,
4) the emulsion obtained in step 3 is subjected to a high shear so as to give a stable miniemulsion having droplets with a mean diameter of between 10 nm to 1000 nm,
5) the miniemulsion obtained in step 4 is polymerized by adding an initiator.

The invention likewise provides the graft copolymer obtainable by the above process.

The invention likewise provides for the use of this graft copolymer as a binder in coating compositions, especially industrial or decorative paint compositions.

To start with we will detail the process for preparing the graft copolymer.

In the first step of the process a modified monomer (A) is prepared by reacting at least one glycidyl ester of acrylic acid or methacrylic acid with at least one semi-drying or drying oil fatty acid.

This is the reaction product of 1 mol of fatty acid and from 0.8 to 1.2 mol of glycidyl ester of acrylic acid or methacrylic acid.

For the preparation of the modified monomer (A) it is possible to use various semi-drying or drying oil fatty acids and various semi-drying oil fatty acids having 4 to 26 carbon atoms.

As examples of these fatty acids mention may be made of safflower oil fatty acid, linseed oil fatty acid, soya oil fatty acid, sesame oil fatty acid, poppy oil fatty acid, perilla oil fatty acid, hempseed oil fatty acid, grapeseed oil fatty acid, maize oil fatty acid, tall oil fatty acid, sunflower oil fatty acid, cottonseed oil fatty acid, whale oil fatty acid, hevea oil fatty acid, sugarcane oil fatty acid, etc.

Among these fatty acids particular preference is given to safflower oil fatty acid, linseed oil fatty acid, soya oil fatty acid, perilla oil fatty acid, hempseed oil fatty acid, tall oil fatty acid and sunflower oil fatty acid.

It is also possible to use unsaturated fatty acids having conjugated double bonds as a portion of the drying oil fatty acid and the semi-drying oil fatty acid. As examples of fatty acids containing conjugated double bonds mention may be made of tung oil fatty acid, oiticica oil fatty acid, dehydrated castor oil fatty acid and Hidiene fatty acid (trade name of fatty acid containing conjugated double bonds, produced by Soken Kagaku Co, Ltd in Japan). The amount of fatty acid containing conjugated double bonds is less than 30% by weight, relative to the total fatty acid.

As glycidyl ester, the other constituent of the modified monomer (A), use may be made of glycidyl acrylate or glycidyl methacrylate. It is also possible to carry out an esterification reaction between the polyunsaturated fatty acid and a hydroxyalkyl (meth)acrylate.

Preference is given to using as glycidyl ester glycidyl acrylate or glycidyl methacrylate.

The modified monomer (A) is customarily prepared by reacting the two above constituents, namely the polyunsaturated fatty acid and the glycidyl acrylate or glycidyl methacrylate, at a temperature of between 40° C. and 220° C., preferably between 60° C. and 100° C., for approximately half an hour to 40 hours, preferably between 3 to 10 hours, in the absence or presence of a reaction catalyst such as tetraethylammonium bromide, although these conditions vary with the type of fatty acid used.

In order to improve the keeping properties of the modified monomer (A) it is possible to add to it a polymerization inhibitor such as hydroquinone, p-benzoquinone or hydroquinone methyl ether (MEHQ).

In the second step of the process this modified monomer (A) obtained in the first step is dissolved in at least one monoethylenically unsaturated monomer (B).

The monoethylenically unsaturated monomer (B) may be selected from monomers customarily used for synthesizing latices.

The monomers are selected such that the graft copolymer obtained has a glass transition temperature (T_{g}) of between −40° C. and +100° C.

The monoethylenically unsaturated monomer (B) may be selected from:
vinyl esters and more particularly vinyl acetate
alkyl acrylates and methacrylates whose alkyl group contains 1 to 10 carbon atoms, for example methyl, ethyl, n-butyl and 2-ethylhexyl acrylates and methacrylates; and
vinylaromatic monomers, especially styrene.

These monomers may be used alone or in mixtures with other ethylenically unsaturated monomers with which they are copolymerizable.

Mention may be made in particular of mixtures of vinylaromatic monomers and especially styrene and alkyl acrylates or methacrylates whose alkyl group contains 1 to 10 carbon atoms, for example methyl, ethyl, n-butyl and 2-ethylhexyl acrylates and methacrylates.

As non-limitative examples of monomers which are copolymerizable with vinyl acetate and/or acrylic esters and/or styrene mention may also be made of ethylene and olefins such as isobutene; vinyl esters of branched or unbranched saturated monocarboxylic acids having 1 to 12 carbon atoms, such as vinyl propionate, vinyl “versatate” (vinyl neodecanoate), vinyl pivalate and vinyl laurate; esters of unsaturated monocarboxylic or dicarboxylic acids having 3 to 6 carbon atoms with alkanols having 1 to 10 carbon atoms, such as methyl, ethyl, butyl and ethylhexyl maleates and fumarates; vinylaromatic monomers such as methytstyrenes and vinyltoluenes; vinyl halides such as vinyl chloride and vinylidene chloride; diolefins, especially butadiene; (meth)allyl esters of (meth)acrylic acid, (meth)allyl esters of the monoesters and diesters of maleic, fumaric and itaconic acids, and alkene derivatives of the amides of acrylic and methacrylic acids, such as N-methallylmaleimide.

It is also possible to use monomers which are copolymerizable with vinyl acetate and/or acrylic esters and/or styrene and which include a functional group allowing the graft copolymer to be endowed with good adhesion properties.
Mention may be made in particular of phosphate monomers which allow good adhesion to be obtained on metallic surfaces, such as vinyl-phosphonic acid, 2-(methacryloyloxy)ethylphosphonic acid (RN 80730-17-2) or 2-(acryloyloxy)ethylphosphonic acid; 2-(methacryloyloxy)ethyl phosphate of formula CH₂═C(CH₃)(COO)C₂H₄OPO₃H, or 2-(acryloyloxy)ethyl phosphate of formula CH₂═CH(COO)C₂H₄OPO₃H; or sulphatoethylammonium methacrylate “SEM”, sold by the company Laporte, or a mixture thereof.

The monoethylenically unsaturated monomer (B) may further comprise functional monomers capable of providing good water resistance and solvent resistance properties, or to endow the latex with specific adhesion properties.

Mention may be made by way of example of 1-methacrylamido-2-imidazolidinoneethane sold under the trade name Sipomer WAM II by the company Rhodia, glycidyl methacrylate, vinyltriethoxysilane or vinyl monomers carrying a cyclodextrin group.

1-Methacrylamido-2-imidazolidinoneethane, sold under the trade name Sipomer WAM II by the company Rhodia, makes it possible to enhance the adhesion of the latex composition to substrates exhibiting carbonyl groups, for example polyester substrates, or previous layers of paint of alkyd type.

Vinyltriethoxysilane makes it possible to enhance the adhesion of the latex composition to glass or other inorganic substrates of metal oxide type.

Glycidyl methacrylate makes it possible to provide the possibility for crosslinking after application of the paint film, by virtue of the presence of epoxy groups.

The monomers copolymerizable with vinyl acetate and/or acrylic esters and/or styrene are generally used in proportions such that the glass transition temperature (T_{g}) of the graft copolymer obtained is between −50° C. and +110° C.

Preferably the monomers copolymerizable with vinyl acetate and/or acrylic esters and/or styrene are used in proportions such that the glass transition temperature (T_{g}) of the graft copolymer obtained is between −40° C. and +60° C.

The proportions of monomers (A) which are dissolved in at least one monoethylenically unsaturated monomer (E) are such that the amount of (A) is between 10 to 80% by weight of modified monomer (A) relative to the total weight of monomers (A)+(B).

Preferably the amount of (A) is between 10 to 50% by weight of modified monomer (A) relative to the total weight of monomers (A)+(B).

In the third step of the process for preparing the graft copolymer the modified monomer (A)/monoethylenically unsaturated monomer (B) solution obtained in step 2 is preemulsified by adding a surfactant and water with stirring, so as to give an emulsion with a water continuous phase, in other words an oil-in-water emulsion.

The organic phase, which is the disperse phase, comprises the monomers (A) and (B). It constitutes in general from 10% to 50% by weight relative to the total weight of the emulsion.

The amount of (A) in the organic phase of the emulsion is between 10 to 80% by weight of modified monomer (A) relative to the total weight of monomers (A)+(B).

Preferably the amount of (A) in the organic phase of the emulsion is between 10 to 50% by weight of modified monomer (A) relative to the total weight of monomers (A)+(B).

Stirring is carried out such that the disperse phase is in the form of droplets having a mean diameter of between 1 to 100 microns. Preferably the mean diameter of the droplets is between 10 to 50 microns.

The surfactant which is used in this third step may be any surfactant conventionally used for emulsion polymerization processes.

The surfactants which may be used are anionic, cationic or nonionic emulsifiers It is possible to use a single surfactant or a mixture of two or more surfactants.

As surfactant use is made generally of the conventional anionic surfactants, represented in particular by the alkyl sulphates, such as sodium lauryl sulphate, alkylsulphonates, alkylaryl sulphates, alkylarylsulphonates such as sodium dodecylbenzenesulphonate, aryl sulphates, arylsulphonates, alkyl ethoxylates, alkylaryl ethoxylates, sulphated or phosphated alkyl ethoxylates or alkylaryl ethoxylates or salts thereof, sulphosuccinates, alkyl phosphates of alkali metals, hydrogenated or non-hydrogenated salts of abietic acid, or salts of fatty acids, such as sodium stearate.

Preference is given to using anionic or nonionic emulsifiers.

They are generally employed in a proportion of from 0.01 to 5% by weight relative to the total weight of the monomers.

It is also possible to couple the use of one of the abovementioned anionic surfactants with a nonionic water-soluble polymer, such as polyvinyl alcohol or polyvinylpyrrolidone (PVP), for example.

It is also possible to couple the use of one of the abovementioned anionic surfactants with a stabilizer system based on anionic synthetic polymers, for example poly(meth)acrytic acid, poly(meth)acrylamide, polyvinylsulphonic acids, and water-soluble copolymers thereof or condensates such as melamine-ormaldehyde sulphonates, naphthalene-formaldehyde sulphonates, styrene/maleic acid copolymers and vinyl ether-maleic acid copolymers.

In the fourth step of the process for preparing the graft copolymer the emulsion obtained in step 3 is subjected to a high shear to give a stable miniemulsion with droplets having a mean diameter of between 10 nm to 1000 nm.

One suitable means for obtaining a high shear suitable for the present invention is, for example, an ultrasound probe, a colloid mill or a homogenizer.

As an example of an ultrasound probe, mention may be made for example of the Vibracell Sonificator 600 W, sold by Bioblock Scientific.

At the end of this fourth step a stable miniemulsion is obtained which has droplets with a mean diameter of between 10 nm to 1000 nm. Preferably the mean diameter of the droplets is between 80 nm and 300 nm.

In the fifth step of the process for preparing the graft copolymer the miniemulsion obtained in step 4 is polymerized by adding an initiator. This is a free-radical polymerization and it may therefore be initiated by a free-radical initiator,

Suitable free-radical initiators are known to the skilled person. Any system may be used which generates free radicals and which is effective at the polymerization temperature. It is possible to use an oil-soluble or water-soluble polymerization initiator.

Systems which generate free radicals include, for example;
organic peroxides, such as benzoyl peroxide, lauroyl peroxyde and dicumyl peroxide,
inorganic persulphates such as sodium persulphate, potassium persulphate, and ammonium persulphate,
azobis(isobutyronitrile) (AIBN),
redox couples such as Fe²⁺/H₂O₂, ROH/Ce⁴⁺ (where R represents an organic group such as a C1-C6 alkyl or C5-C8 aryl group) or K₂S₂O₈/Fe²⁺.

It is employed in an amount of between 0.05 and 2% by weight relative to the total of the monomers.

The reaction temperature, which is a function of the initiator employed, is generally between 0 and 100° C. and preferably between 30 and 90° C.

The preferred polymerization temperature depends on the selection of the initiator.

The size of the particles of graft copolymer which forms in the emulsion is between 60 nm and 300 nm, in other words a size of the same order of magnitude as the mean diameter of the monomer droplets of the miniemulsion from step 4.

There is no substantial change in the size of the particles of graft copolymer.

Accordingly a graft copolymer is obtained which is composed of small particles whose mean diameter is between 60 nm and 300 nm.

In general the polymerization is carried out in a reactor which has been charged beforehand with:
water,
a surfactant selected from the list of surfactants employed to produce the emulsion in step 3 of the above preparation process, and
an initiator

This mixture is heated to the polymerization temperature and the miniemulsion prepared in step 4 is added continuously, to allow more effective control of the exothermic nature of the polymerization.

It is additionally possible to use a transfer agent in proportions ranging from 0 to 3% by weight relative to the monomer(s), this agent generally being selected from mercaptans such as N-dodecyl mercaptan or tert-dodecyl mercaptan, cyclohexene, halogenated hydrocarbons such as chloroform, bromoform and carbon tetrachloride. The transfer agent makes it possible to regulate the length of the molecular chains. It is added to the reaction mixture either before polymerization or during polymerization.

The invention likewise provides the graft copolymer obtainable by the process described above.

The aqueous dispersion of graft copolymer can be used as it is or else can be dried to give a powder.

Depending on the uses of the graft copolymer, appropriate dying methods will be employed.

Thus if the graft copolymer is to be used as a binder in a coating composition such as a paint composition it is possible to employ the drying methods customarily used for producing powder coatings.

Powder coatings may be described as “solid paints” which can be melted to form a continuous film on the substrate (often metal, although wood, certain wood substitutes, ceramic, glass and certain plastics may also be coated). The powders may be thermoplastic or thermosetting.

Thermosetting powders crosslink and polymerize under heat, while the thermoplastic powders remain sensitive to heat. Consequently the term “powder coatings” employed in industry generally refers to thermosetting powder coatings.

These coating materials are readily applied to the substrate by gun, by means of an electrostatic or tribostatic method: as the thickness increases, the coating material undergoes “self-limitation” so as to produce a relatively homogeneous film thickness. The powder-coated article is then dried in an oven. The powder melts and forms a continuous film, before undergoing chemical reaction to become an inert, solid coating. These coating materials exhibit a certain number of advantages relative to traditional liquid paints, particularly from an environmental standpoint, given that they are 100% solid, and contain virtually no volatile organic compounds. The emissions to the environment are negligible.

The process for producing powder coatings and their application method are described in the following paragraphs:

1) Premixing

After precise weighing, all of the dry raw material (polymer, pigment, additives) is mixed in a large mixer to give a mixture which is as homogeneous as possible. To some extent the procedure resembles the mixing of liquid paint, with the difference that the shade and all of the other properties of the finished powder are fixed at this point in time. The mixture must therefore be perfect.

2) Extrusion

The premix is then passed to an extruder, comprising a heated tube in which (generally) two screws rotate. The combination of heat and friction caused by the shearing of the screws causes the resin to melt and effects thorough mixing of all the other ingredients (primarily the pigments and the fillers), dispersing them in the melted resin. The ingredients remain in the extrusion zone for only about 15 seconds. It is therefore vital to have a homogeneous premix in order to obtain a homogeneous powder coating. The mixture emerges from the extruder as a hot (about 130° C.) and extremely viscous liquid. Given that the resin is thermosetting, it is imperative to cool the mixture as quickly as possible so as to prevent any curing reaction. The extruded product immediately enters a system of water-cooled pinch rolls, which flatten it to give a fine strip (approximately 2 mm thick and 1 m wide) with a large surface area. The strip is still slightly hot at this point in time (approximately 70-80° C.), but its temperature is reduced to ambient temperature as it passes onto a likewise water-cooled metal conveyor.

At the end of the conveyor the strip is at ambient temperature and is brittle, ready to be granulated into storage containers.

3) Milling

The granulated “chips” are then conveyed to a mill. This mill comprises a rotor which has teeth and rotated at approximately 6000 revolutions/min within a jagged-walled chamber. The chips are thrown vigorously against the teeth, the wall and the other chips until they are converted into a fine powder.

4) Application of the Powder

There are two main types of electrostatic gun: the corona discharge gun, and tribostatic guns.

The invention likewise provides the graft copolymer powder obtainable by the powder coating preparation process.

Similarly, in the case of use of the graft copolymer as binder in a mineral binder composition such as a mortar, it is possible to employ the drying methods which are commonly used to produce redispersible polymer powders.

The redispersible powder is prepared preferably by spray-drying the aqueous dispersion of graft copolymer, optionally under nitrogen to avoid double-bond oxidation of the grafted copolymer. This drying is carried out in conventional spray-drying systems, employing atomization by means of single, double or multiple liquid nozzles or a rotating disc. The discharge temperature selected is generally in the range from 50 to 100° C., preferably from 60 to 90° C., depending on the system, the glass transition temperature of the graft copolymer, and the desired degree of drying.

In order to enhance the preservation stability and the flow capability of the redispersible graft copolymer powder it is preferable to introduce an anticaking agent into the spraying column in unison with the aqueous dispersion of graft copolymer, resulting in preferable deposition of the anticaking agent on the particles of the dispersion.

Preferred anticaking agents are aluminium silicates, calcium or magnesium carbonates, or mixtures thereof, silicas, hydrated alumina, bentonite, talc, or mixtures of dolomite and talc, or of calcite and talc, kaolin, barium sulphate, titanium oxide, or calcium sulphoaluminate (satin white).

The particle size of the anticaking agents is preferably in the range from 0.001 to 0.5 mm.

It is also possible before drying to introduce a conventional redispersion agent such as, for example, polyvinyl alcohol, N-vinylpyrrolidone, formaldehydelnaphthalenesulphonic acid condensates, formaldehyde/phenylsulphonic acid condensates, or 2-acrylamido-2-methylpropane-sulphonic acid homopolymers.

The invention likewise provides the redispersible graft copolymer powder obtainable by the process described above.

In the majority of cases the pulverulent compositions according to the invention are completely redispersible in water at ambient temperature by simple agitation. By totally redispersible is meant a pulverulent composition in accordance with the invention which, following the addition of an appropriate amount of water, allows a reconstituted graft copolymer to be obtained whose particle granulometry is substantially identical to the granutometry of the graft copolymer particles present in the initial emulsion before drying.

Following this redispersion, the particle size of the reconstituted graft copolymer obtained is measured by laser granuiometry. The closer the granulometry of the reconstituted graft copolymer to that of the graft copolymer used to synthesize the pulverulent composition, the better the redispersibility.

The invention likewise provides the reconstituted graft copolymer obtained by redispersing a pulveruient composition as defined above in water.

Finally the invention provides for the use of the graft copolymers of the invention as a binder in coating compositions, and in particular in industrial or decorative paint compositions, or else as a binder in adhesive compositions, or else as a binder in mineral binder compositions such as mortars.

The graft copolymer-based binder compositions of the invention exhibit improved solvent resistance and improved mechanical strength.

If the binders are those used in coating compositions, this improved solvent resistance and improved mechanical strength will thus increase their lifetime or the duration of their presence on the substrate which they are protecting. Their ageing stability may also be increased. Their resistance to changes in the size of the substrate may be increased as well.

In the present description the term “paint” is employed in the wide sense to designate any polymeric-type coating deposited on a substrate and able to have in particular a function of protecting that substrate, and more particularly to denote aqueous paints proper, varnishes and stains. The terms “stain” and “varnish” have the usual meaning within the technical field in question here. To specify, a stain is generally a transparent or semi-transparent composition or formulation which is applied to the wood or the substrate and is intended to protect it, and whose solids content can be of the order of 10% by weight or of the order of 40 to 50% by weight, depending on whether it is a priming or finishing stain A varnish is a more concentrated composition or formulation than a stain.

The invention applies generally to any type of aqueous paint, particularly to all types of stain or varnish, used on any substrate.

This substrate may in particular be wood or metals, or a mineral substrate without a covering of paint, or a substrate covered with a primer or an old layer of paint requiring renovation.

Where the substrate is a metal the invention may apply to paints for cars. When the graft copolymer of the invention is used as a binder in a coating composition the amount of graft copolymer present in a coating composition is between 10 to 95% by volume fraction. Preferably when the graft copolymer of the invention is used as a binder in a coating composition the amount of graft copolymer present in a coating composition is between 20 to 85% by volume fraction.

When the graft copolymer of the invention is used as a binder in a mineral binder composition the amount of graft copolymer present in a mineral binder composition is between 0.5 to 30% by mass fraction.

Preferably when the graft copolymer of the invention is used as a binder in a mineral binder composition the amount of graft polymer present in a mineral binder composition is between 1 to 10% by mass fraction.

By mineral binder is meant air-setting binders or hydraulic binders.

Among the air-setting binders mention may be made of plasters,

Among the hydraulic binders mention may be made of cements, which may be of Portland, alumina or blast-furnace type, fly ashes, calcined schists or pozzolanas.

The hydraulic binders are preferably cements.

The mineral binders have the property of crystallizing in the presence of water, and hence of “setting”. With water they form a paste which gradually hardens, even in the absence of air and in particular under water. Mixtures of sand and chippings, and depending on their type, they may form concretes, mortars or road construction sand/gravel mixes.

When the graft copolymer of the invention is used as a binder in an adhesive composition the amount of graft copolymer present in an adhesive composition is between 70 to 100% by volume fraction,

Preferably when the graft copolymer of the invention is used as a binder in an adhesive composition the amount of graft copolymer present in an adhesive composition is between 80 to 100% by volume fraction.

The invention also applies to varnishes used in cosmetology.

Depending on the intended application and the level of desired performance, it may be appropriate to use graft copolymers of the invention in compositions including a siccative. This is the case for coating compositions or adhesive compositions.

The siccative is a catalyst which promotes the oxidation of the double bonds corresponding to the unsaturations of the fatty acid. Use of a siccative allows crosslinking of the binder to be accelerated and a good level of mechanical strength and solvent resistance to be attained more rapidly.

However, the graft copolymer according to the invention allows good mechanical characteristics and solvent resistance to be attained without the addition of siccative.

This implementation may be of interest where the user wishes to avoid the presence of heavy metals (cobalt salts, for example) in order to meet requirements for respecting the environment.

The coating composition, paint or varnish comprising the graft copolymer of the invention, following its application to a substrate, may be dried at ambient temperature. This drying may also be effected at high temperature if the application conditions allow it, i.e. at between 30° C. and 300° C. and preferably between 30° C. and 100° C., which has the result of further increasing the level of crosslinking.

The examples which follow illustrate the invention, though without limiting its scope.

### EXAMPLES

### Example A

### Preparation of the Copolymers Grafted with Unsaturated Fatty Acids and Preparation of Comparative Examples

### Example 1

### According to the Invention—Synthesis of an Acrylic/Polyunsaturated Fatty Acid Methacrylate Hybrid (O3BBT021)

a) Synthesis of a Polyunsaturated Fatty Acid Methacrylate

1657.8 g of tall oil fatty acid, 839.2 g of glycidyl methacrylate, 2.5 g of triphenylmethylphosphonium bromide and 0.5 g of 1,4-dihydroxybenzene are charged together in a round-bottomed flask equipped with a reflux condenser, a stirrer and a heating means. The mixture is stirred and air is bubbled through. The mixture is heated to a temperature of 140° C. This temperature is maintained for 2 hours until all the fatty acids are consumed. This mixture is cooled to room temperature and 0.25 g of 1,4-dihydroxybenzene is added. The product is stored at room temperature.

b) Synthesis of the Acrylic/Polyunsaturated Fatty Acid Methacerylate Hybrid

The polyunsaturated fatty acid methacrylate of step a) is dissolved in a mixture of styrene (302 g), butyl acrylate (226 g) and acrylic acid (8 g). This solution is dispersed in an aqueous solution of water (377 g), sodium lauryl sulphate (8 g. SLS surfactant), Disponil FES 32 IS (2.44 g, ethoxylated surfactant sold by Cognis), Sipomer WAM II (11 g, sold by Rhodia) and sodium persulphate (1.5 g).

The dispersion is homogenized using an Ultra-Turrax (Janke & Kunkel) homogenizer to give a preemulsion having droplets with a mean diameter of 10 μm.

The resulting preemulsion is subjected to a high shear (ultrasound, Vibracell Sonificator 6000 W Bioblock Scientific (output 30%) to give a stable miniemulsion having droplets with a mean diameter of 190 nm.

A polymerization reactor equipped with a stirrer blade (anchor) and condenser is thermostated at 80° C. A solution of water (300 g), SLS (4.4 g), Disponil FES 32IS (0.78 g) and sodium persulphate (1.5 g) is introduced into the reactor and, when the temperature of the solution is stabilized at 80° C., the miniemulsion is introduced over 4 hours.

At the end of the introduction the temperature is held at 80° C. for one hour.

The resulting latex is cooled and diluted with water.

This latex has the following characteristics: solids content 43.5%, pH1.8, mean diameter 170 nm.

### Comparative Example 1

A styrene-acrylic latex with a minimum film-forming temperature at 16° C. produced by Rhodia under the name Rhodopas DS913.

### Comparative Example 2

An alkyd resin emulsion produced by DSM under the name Uradil AZ562 Z50, with the addition of 0.5% of Nuoddx web-Co 8, siccative produced by Elementis.

### Comparative Example 3

A mixture of alkyd resin emulsion and styrene-acylic latex made so as to have the same mass proportions of alkyds and latex as the two hybrid binders of the invention. The chemical compositions of the alkyd emulsion and the latex are comparable to the chemical composition of the binders of the invention.

### Comparative Example 4

### 03aBT024

Step b) of Example 1 according to the invention was carried out, but replacing the fatty acid methacrylate prepared in step a) of Example 1 by an alkyd resin Z 474, sold by DSM Resins.

The alkyd resin/acrylic copolymer ratio is 40%/60% by weight. At this ratio, the end product still contains 15% of fatty acid, which represents for comparison an acid content identical to that of Example 1 according to the invention and also a styrene and acrylic monomers ratio identical to that of Example 1 according to the invention.

### Example B

### Description of the Tests Used

A description will first be given of the various tests which we used, followed by a presentation of the results obtained for the inventive examples and the comparative examples.

I—Rub Test with Methyl Ethyl Ketone

1. Principle

This test consists in subjecting the varnish or paint film to repeated rubs with a piece of cotton soaked with methyl ethyl ketone (MEK) and in examining the area tested. Since the result of this test is relatively dependent on the operator, it is recommended that a reference product be tested in parallel or that this test be considered as a comparative method.

2. Bibliographic References

The present procedure is based on standard ASTM D4752 of 1987.

3. Equipment and Products

The test is carried out on aluminium substrate AL36 (chromated aluminium) supplied by Q-PANEL. It also uses hydrophilic cotton and methyl ethyl ketone (no particular specification).

4. Procedure

The support is a binder film applied at 150 microns wet to a metal plaque.

The cotton is soaked with methyl ethyl ketone.

The film under test is rubbed with this cotton, with a pressure of approximately 2 kg, in back-and-forth movements.

The test is halted when the cotton begins to stick to the film or after 20 double rubs it nothing is happening.

The surface is examined.

Further methyl ethyl ketone is applied to the cotton if the latter appears dry, and the test is recommenced.

The test is halted when the substrate appears. If it does not appear, the test continues up to the maximum: 200 double rubs.

Note: One double rub is one back-and-forth rub performed on the plaque.

II—Chemical Resistance Test: “Drop Test”

1. Principle

The binder film is contacted with a drop of chemical product for a period of 30 min. Following this exposure, the condition of the film is evaluated. It is recommended that a reference product be placed among those tested, so as to use this test as a comparative method.

2. Equipment and Products

The test binder is applied at 150 microns wet to a metal plaque of chromated aluminium type (reft AL36 supplied by Q-PANEL)

10 The following chemical agents are used:
sulphuric acid at approximately 10% (by weight),
acetic acid at approximately 25% (by weight),
aqueous ammonia at approximately 20% (by weight),
ethanol 96°,
xylene,
methyl ethyl ketone.

3. Procedure

A drop of the reagent is placed on the binder. The assembly is covered with a watchglass or a plastic stopper. After 30 min the reagent is removed from the film by wiping using an absorbent paper.

4. Reporting of Results

The condition of the binder film is evaluated by awarding a score from 0 to 5 according to the following scheme:
0: The film is not attacked; the reagent leaves no trace at all.
1: A mark is observed corresponding to the outline of the drop. The interior is identical to the remainder of the film in appearance and feel.
2: A loss of gloss is observed, or the film is tacky (highly softened), or coloration.
3: The film has 2 or 3 of the defects under rating 2.
4: The film is wrinkled or gummy without any real cohesion. Additionally a rim can be observed at the periphery of the drop.
5: The film has been destroyed completely and the substrate is bare.

III—Persoz Hardness

1. Principle

The test consists in measuring the damping time of a pendulum which rests via two steel balls on the film under study.

2. Bibliographic References

The present procedure was drawn up along the lines of standard NFT 30-016 of December 1991.

3. Procedure

The test is carried out in a room in which the atmosphere is maintained at a temperature of (23±3° C.) and the relative humidity at (55±10%).

The test specimen is fixed to the platform. The horizontality of the apparatus is checked using a spirit level.

It is ensured that the beads are in good condition, using a magnifying glass if appropriate. If necessary, degreasing is carried out and then the pendulum is placed on the film under study.

A check is made that the mirror or the photoelectric cell is parallel to the plane of displacement of the pendulum and that the zero point of the mirror or cell and the resting position of the pendulum coincide. An adjustment is made if necessary. The pendulum is lifted to the 12° graduation, and it is let go and, at the same time, the stopwatch is started.

The stopwatch is stopped when the amplitude reaches 4°. In the case of instruments with an automatic counting system, these operations are performed automatically, but the type of instrument must be taken into account.

To avoid a parallax error, the eye of the tester must be positioned such that he or she can see his or her own image behind the 0° graduation.

4. Reporting of Results

The hardness result is the number of seconds obtained by calculating the mean of 2 successive determinations performed in 2 different places on the same test specimen.

IV—Measurement of Elongation on Free Composites

1. Principle

The test consists in stretching to break standard-size test specimens on a tensile testing machine capable of ensuring a constant displacement speed of the jaw or of the moving roller.

2. Bibliographic Reference

The present procedure was drafted in accordance with standard P2 507c.

3. Apparatus Required

A tensile machine is used which
is able to maintain a constant speed of the moving jaw or moving roller, at plus or minus 10% of the actual value,
equipped with jaws which ensure that the test specimens heads are gripped throughout the test so as to prevent sliding, without exerting localized stresses which could result in the tearing or breaking of the ends of the sample.

4. Preparation of Dumbbell Test Specimens

4.1 Dimensions

The test specimens used for this type of test are cut from an H3-type punch, with a total length of 50 mm.

The thicknesses are generally between 0.5 and 1 mm.

4.2 Cutting

The film to be cut is placed with or without siliconized paper onto a flat surface plaque in a material sufficiently flexible not to damage the punch.

The test specimens are cut in a single operation by means of the appropriate equipment.

Each test specimen is examined, and those which exhibit defects or incipient fractures visible to the naked eye are rejected.

4.3 Size Measurement

The thickness is measured at three different points distributed over the central portion of the test specimen.

The mean of the three measurements is taken.

The width of the test specimen is taken to be the width between edges of the central portion of the punch.

5. Procedure

5.1 Conditioning of the Test Specimens

The test is carried out under standard conditions of temperature and hygrometry, 23° C.±2° C., 55%±5% relative humidity.

5.2 Test Technique

The test specimen is positioned, avoiding as far as possible contact with the central portion, in the attachment device, whose initial spacing is known and preset.

The tensile machine is started at a speed of 50 mm/min until the test specimen breaks.

V—Taber Scarring Resistance

1. Principle

The test consists in measuring the minimum toad required to cause a regular scar to appear on a rotating test specimen. An arm fitted with a weight allows the load applied to the scarring tool (a diamond tip) to be varied on the film under study.

2. Bibliographic References

The present procedure was drawn up along the lines of standard EN 438 and ISO 4585-2.

3. Apparatus

The Taber scarring resistance measurement apparatus is referenced as model 203.

4. Test Specimens

The measurements are carried out on the binders applied to glass plaques at a thickness of 150 microns wet.

Before the test the test specimens are allowed to spend at least 12 h in a room where the temperature is (23±3° C.) and the relative humidity is (55±10%).

5. Procedure

The test is carried out in a room where the atmosphere is maintained at a temperature of (23±3° C.) and the relative humidity at (55±10%). The test specimen is fixed to the platform used to rotate the specimen. The horizontality of the apparatus is checked by means of a spirit level.

The oscillating arm, equipped with a diamond tip, is applied to the varnish film, the weight being set so as to have the lowest pressure.

One rotation of the test specimen is carded out.

The presence or absence of scarring is ascertained.

If scarring is absent, the pressure of the oscillating arm is increased by adjusting the weight.

Measurement is recommenced until a regular, continuous scar appears.

A record is made of the pressure applied.

6. Reporting of the Results

The scarring resistance result is the minimum pressure in grams for the appearance of a continuous, regular scar, obtained by calculating the mean of 2 successive determinations carried out in 2 different places on the same test specimen.

### Examples C

### Results Obtained with the Examples of the Invention and the Comparative Examples

### Example C-1

This example relates to the evaluation of the two binders of the invention dried in the pure state at 23° C. and 55% relative humidity for one month. Table 1 summarizes the products tested and their comparative

TABLE 1

| Additive | Nomenclature |
|---|---|
| Comparative Example 3 | Alkyd latex mixture |
| Comparative Example 4 | 03BBT024 |
| Inventive Example 1 | 03BBT021 |

The rub tests are given in Table 2 below.

TABLE 2

| Additive | Rub test (number of cycles) |
|---|---|
| Comparative Example 3 | 15 |
| Comparative Example 4 | 12 |
| Inventive Example 1 | 42 |

It is observed from Table 2 that the binders of the invention have better crosslinking than the binder mixture (Comparative Example 3) and than the binder (Comparative Example 4).

The chemical resistance results are given in Table 3 below.

TABLE 3

| | Sulphuric | Acetic | Aqueous | Methyl | | |
|---|---|---|---|---|---|---|
| | acid | acid | ammonia | ethyl | Xy- | Ethanol |
| Additive | (10%) | (25%) | (20%) | ketone | lene | (96°) |
| Comparative | 0 | 2 | 2 | 3 | 4 | 3 |
| Example 3 | | | | | | |
| Comparative | 3 | 3 | 3 | 5 | 5 | 2 |
| Example 4 | | | | | | |
| Inventive | 0 | 0 | 1 | 1 | 4 | 2 |
| Example 1 | | | | | | |

An overall improvement is observed in the chemical resistance of the examples according to the invention relative to Comparative Example 4 and to the binder mixture (Comparative Example 3).

The results of Persoz hardness are given in Table 4 below.

TABLE 4

| Additive | Hardness (seconds) |
|---|---|
| Comparative 3 | 77 |
| Comparative 4 | 15 |
| Inventive Ex. 1 | 104 |

Table 5 below summarizes the results of elongation on free composites.

TABLE 5

| | % elongation at | Maximum stress |
|---|---|---|
| Additive | break | (MPa) |
| Comparative Example 3 | 740 | 1.1 |
| Comparative Example 4 | 450 | 0.6 |
| Inventive Example 1 | 439 | 8.15 |

The copolymer according to the invention has improved mechanical characteristics, which are characterized by
a greater hardness;
an increase in the maximum stress while maintaining a sizable level of deformation;
a greater scarring resistance.

Table 6 below summarizes the Taber scarring resistance results. The parameter recorded is the pressure in grams required to form a scar.

TABLE 6

| Additive | Pressure (grams) |
|---|---|
| Comparative 3 | 10 |
| Comparative 4 | 10 |
| Inventive Ex. 1 | 20 |

### Example C-2

This example relates to the evaluation of the binder of Example 1 of the invention dried so as to form a film of pure binder under optimum crosslinking conditions; therefore a siccative was added and drying was carried out at high temperature.

Table 7 indicates the test products, examples according to the invention or comparative examples,.and the duration and temperature of drying for each of the products.

TABLE 7

| Additive | Description |
|---|---|
| Comparative 1 | Latex Rhodopas DS913 dried 4 hours at 60° C. |
| Comparative 2 | Alkyd emulsion Uradil AZ562Z50 with |
| | siccative (0.5% Nuodex Web Co8) dried |
| | 4 hours at 60° C. |
| Comparative 3 | Alkyd latex mixture with siccative (0.5% |
| | Nuodex Web Co8) dried 4 hours at 60° C. |
| Comparative 4 | 03BBT024 with siccative (0.5% Nuodex Web |
| | Co8) dried 4 hours at 60° C. |
| Inventive Example 1 | 03BBT021 with siccative (0.5% Nuodex Web |
| | Co8) dried 4 hours at 60° C. |

The rub tests are given in Table 8 below.

TABLE 8

| Additive | Rub test (number of cycles) |
|---|---|
| Comparative 1 | 67 |
| Comparative 2 | 17 |
| Comparative 3 | 139 |
| Comparative 4 | 114 |
| Inventive Ex. 1 | >200 |

It is observed from Table 8 that the binders of the invention (Examples 1 and 2) have better crosslinking than the binder mixture (Comparative Example 3) and than the binder of Comparative Example 4.

The chemical resistance results are given in Table 9 below.

TABLE 9

| | Sulphuric | Acetic | Aqueous | Methyl | | |
|---|---|---|---|---|---|---|
| | acid | acid | ammonia | ethyl | Xy- | Ethanol |
| Additive | (10%) | (25%) | (20%) | ketone | lene | (96°) |
| Comparative | 0 | 0 | 0 | 4 | 4 | 3 |
| Example 1 | | | | | | |
| Comparative | 0 | 2 | 1 | 5 | 4 | 2 |
| Example 2 | | | | | | |
| Comparative | 0 | 2 | 1 | 3 | 2 | 2 |
| Example 3 | | | | | | |
| Comparative | 2 | 3 | 3 | 5 | 4 | 2 |
| Example 4 | | | | | | |
| Inventive | 0 | 0 | 1 | 1 | 1 | 1 |
| Example 1 | | | | | | |

An overall improvement in the chemical resistance is recorded for the binder of the invention.

The Persoz hardness results are given in Table 10 below.

TABLE 10

| Additive | Hardness (seconds) |
|---|---|
| Comparative 1 | 154 |
| Comparative 2 | 43 |
| Comparative 3 | 110 |
| Comparative 4 | 41 |
| Inventive Ex. 1 | 155 |

Table 11 below summarizes the results of elongation on free composites.

TABLE 11

| | % elongation at | Maximum stress |
|---|---|---|
| Additive | break | (MPa) |
| Comparative 1 | 360 | 11 |
| Comparative 2 | 80 | 0.6 |
| Comparative 3 | 390 | 8.8 |
| Comparative 4 | 310 | 5.4 |
| Inventive Example 1 | 320 | 16.3 |

Table 12 below summarizes the Taber scarring resistance results. The parameter recorded is the pressure in grams required to form a scar.

TABLE 12

| Additive | Pressure (grams) |
|---|---|
| Comparative 1 | 10 |
| Comparative 2 | 10 |
| Comparative 3 | 10 |
| Comparative 4 | 10 |
| Inventive Ex 1 | 30 |

The graft copolymer of Example 1 of the invention exhibits mechanical characteristics which are further improved, owing to more advanced crosslinking (addition of siccative), which are characterized by
a greater hardness;
an increase in the maximum stress while maintaining a sizable level of deformation;
a greater scarring resistance.

1. Process for grafting a copolymer with a polyunsaturated fatty acid, comprising the following steps:
1) a modified monomer (A) is prepared by reacting at least one glycidyl ester of acrylic acid or methacrylic acid with at least one semi-drying or drying oil fatty acid,
2) this modified monomer (A) obtained in the first step is dissolved in at least one monoethylenically unsaturated monomer (B),
3) the modified monomer (A)/monoethylenically unsaturated monomer (B) solution obtained in step 2 is then preemulsified by adding a surfactant and water with stirring, so as to give an emulsion with a water continuous phase, in other words an oil-in-water emulsion,
4) the emulsion obtained in step 3 is subjected to a high shear so as to give a stable miniemulsion having droplets with a mean diameter of between 10 nm to 1000 nm,
5) the miniemulsion obtained in step 4 is polymerized by adding an initiator.

2. Process according to claim 1, characterized in that in step 11 mol of fatty acid is reacted with 0.8 to 1.2 mol of glycidyl ester of acrylic acid or methacrylic acid.

3. Process according to claim 1, characterized in that the fatty acid of drying or semi-drying oils has a number of carbon atoms of between 4 to 26 carbon atoms.

4. Process according to claim 1, characterized in that the fatty acid is selected from safflower oil fatty acid, linseed oil fatty acid, soya oil fatty acid, sesame oil fatty acid, poppy oil fatty acid, perilla oil fatty acid, hempseed oil fatty acid, grapeseed oil fatty acid, maize oil fatty acid, tall oil fatty acid, sunflower oil fatty acid, cottonseed oil fatty acid, whale oil fatty acid, hevea oil fatty acid, sugarcane oil fatty acid, or a mixture thereof.

5. Process according to claim 4, characterized in that the fatty acid is selected from safflower oil fatty acid, linseed oil fatty acid, soya oil fatty acid, perilla oil fatty acid, hempseed oil fatty acid, tall oil fatty acid and sunflower oil fatty acid, or a mixture thereof.

6. Process according to claim 1, characterized in that the fatty acid comprises a portion of unsaturated fatty acids having conjugated double bonds as a portion of the drying oil fatty acid and of the semi-drying oil fatty acid.

7. Process according to claim 6 characterized in that the unsaturated fatty acid having conjugated double bonds is selected from tung oil fatty acid, oiticica oil fatty acid, dehydrated castor oil fatty acid and Hidiene fatty acid (trade name of fatty acid containing conjugated double bonds, produced by Soken Kagaku Co, Ltd in Japan).

8. Process according to claim 6, characterized in that the amount of fatty acid containing conjugated double bonds is less than 30% by weight, relative to the total fatty acid.

9. Process according to claim 1, characterized in that the modified monomer (A) is prepared in step 1 by reacting the 2 constituents at a temperature of between 40° C. and 220° C., preferably between 60 and 100° C., for approximately half an hour to 40 hours, preferably between 3 to 10 hours in the absence or presence of a reaction catalyst such as tetraethylammonium bromide.

10. Process according to ay one of the preceding claim 1, characterized in that the monoethylenically unsaturated monomer (B) is selected such that the graft copolymer obtained has a glass transition temperature (Tg) of between −40° C. and +100° C.

11. Process according to claim 1, characterized in that the monoethylenically unsaturated monomer (B) is selected from:
vinyl esters and more particularly vinyl acetate;
alkyl acrylates and methacrylates whose alkyl group contains 1 to carbon atoms, for example methyl, ethyl n-butyl and 2-ethylhexyl acrylates and methacrylates; and
vinylaromatic monomers, especially styrene, it being possible for these monomers to be used alone or in mixtures with other monomers containing ethylenic unsaturation with which they are copolymerizable.

12. Process according to claim 11, characterized in that the monoethylenically unsaturated monomer (B) is selected from mixtures of vinylaromatic monomers and especially styrene and alkyl acrylates or methacrylates whose alkyl group contains 1 to 10 carbon atoms, for example methyl, ethyl, n-butyl and 2-ethylhexyl acrylates and methacrylates.

13. Process according to claim 11, characterized in that the monomers which are copolymerizable with vinyl acetate and/or acrylic esters and/or styrene are selected from ethylene and olefins such as isobutene; vinyl esters of branched or unbranched saturated monocarboxylic acids having 1 to 12 carbon atoms, such as vinyl propionate, vinyl “versatate” (vinyl neodecanoate), vinyl pivalate and vinyl laurate; esters of unsaturated monocarboxylic or dicarboxylic acids having 3 to 6 carbon atoms with alkanols having 1 to 10 carbon atoms, such as methyl, ethyl, butyl and ethylhexyl maleates and fumarates; vinylaromatic monomers such as methylstyrenes and vinyltoluenes; vinyl halides such as vinyl chloride and vinylidene chloride; diolefins, especially butadiene; (meth)allyl esters of (meth)acrylic acid, (meth)allyl esters of the monoesters and diesters of maleic, fumaric and itaconic acids, and alkene derivatives of the amides of acrylic and methacrylic acids, such as N-methallylmaleimide.

14. Process according to claim 11, characterized in that the monomers
copolymerizable with vinyl acetate and/or acrylic esters and/or styrene are selected from:
phosphate monomers, such as vinylphosphonic acid, 2-(methacryloyl-oxy)ethylphosphonic acid (RN 80730-17-2), or 2-(acryloyloxy)ethylphos-phonic acid; 2-(methacryloyloxy)ethyl phosphate of formula CH₂═CH₃)(COO)C₂H₄OPO₃H, or 2-(acryloyloxy)ethyl phosphate of formula CH₂CH(COQ)CzH₄OPO₃H; or sulphatoethylammonium methacrylate “SEM” sold by the company Laporte, or a mixture thereof;
1-methacrylamido-2-imidazolidinoneethane, glycidyl methacrylate, vinyltriethoxysilane or vinyl monomers which carry cyclodextrin group.

15. Process according to claim 1, characterized in that in step 2 the proportions of monomers (A) which are dissolved in at least one monoethylenically unsaturated monomer (B) are such that the amount of (A) is between 10% to 80% by weight of modified monomer (A) relative to the total weight of monomers (A)+(B), and preferably the amount of (A) is between 10% to 50% by weight of modified monomer (A) relative to the total weight of monomers (A)+(B).

16. Process according to claim 1, characterized in that in the third step the organic phase comprising the monomers (A) and (B) constitutes from 10% to 50% by weight relative to the total weight of the emulsion.

17. Process according to claim 1, characterized in that in the third step stirring is carried out such that the disperse phase is in the form of droplets having a mean diameter of between 1 micron to 100 microns, and preferably the mean diameter of the droplets is between 10 microns to 50 microns.

18. Process according to claim 1, characterized in that in the third step the surfactant used is selected from conventional anionic surfactants, represented in particular by the alkyl sulphates, such as sodium lauryl sulphate, alkylsulphonates, alkylaryl sulphates, alkylarylsulphonates such as sodium dodecylbenzenesulphonate, aryl sulphates, arylsulphonates, alkyl ethoxylates, alkylaryl ethoxylates, sulphated or phosphated alkyl ethoxylates or alkylaryl ethoxylates or salts thereof, sulphosuccinates, alkyl phosphates of alkali metals, hydrogenated or non-hydrogenated salts of abietic acid, or salts of fatty acids, such as sodium stearate.

19. Process according to claim 1, characterized in that in the third step the amount of surfactant used is between 0.01 to 5% by weight relative to the total weight of the monomers.

20. Process according to claim 1, characterized in that in the third step the surfactant used is combined with a nonionic water-soluble polymer, such as polyvinyl alcohol or polyvinylpyrrolidone (PVP), for example, or with a stabilizer system based on anionic synthetic polymers, for example poly(meth)acrylic acid, poly(meth)acrylamide, polyvinylsulphonic acids, and water-soluble copolymers thereof, or condensates such as melamine-formaldehyde sulphonates, naphthalene-formaldehyde sulphonates, styrene/maleic acid copolymers or vinyl ether-maleic acid copolymers.

21. Process according to claim 1, characterized in that at the end of this fourth step a stable miniemulsion is obtained which has droplets with a mean diameter of between 60 nm and 300 nm.

22. Process according claim 1, characterized in that in the fifth step the free-radical initiator is selected from
organic peroxides, such as benzoyl peroxide, lauroyl peroxyde and dicumyl peroxide,
inorganic persulphates such as sodium persulphate, potassium persulphate, and ammonium persulphate,
azobis(isobutyronitrile) (AIBN), or
redox couples such as Fe²⁻/H₂O2, ROH/Ce^{4t} (where R represents an organic group such as a C1-C6 alkyl or C5-C8 aryl group) or K₂S₂Oa/Fe^{2t}

23. Process according claim 1, characterized in that in the fifth step the free-radical initiator is used in an amount of between 0.05 and 2% by weight relative to the total of the monomers.

24. Process according to claim 1, characterized in that in the fifth step the polymerization temperature is between 0 and 100° C., and preferably between 30 and 90° C.

25. Graft copolymer obtainable by the process according to claim 1.

26. Graft copolymer obtainable by the process according to claim 1, characterized in that it is in powder form.

27. Graft copolymer obtainable by the process according to claim 1 characterized in that it is in redispersible powder form.

28. Reconstituted graft copolymer obtained by redispersing in water a pulverulent composition according to claim 27.

29. Use of the graft copolymer according to claim 25 as a binder in coating compositions, adhesive compositions or mineral binder compositions.

30. Coating or adhesive or mineral binder composition comprising a graft copolymer according to claim 25.

31. Coating or adhesive composition according to claim 30, characterized in that this composition further comprises a siccative.
